(19) United States
(12) Patent Application Publication
(10) Pub. No.: US 2004/0081582 A1
(43) Pub. Date: Apr. 29, 2004

(54) Cell phone/breath analyzer

(75) Inventor: Richard B. Brooke, Coeur D'Alene, ID (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Oxyfresh Worldwide, Inc.

(21) Appl. No.: 10/659,099

(22) Filed: Sep. 10, 2003

Related U.S. Application Data
(60) Provisional application No. 60/409,481, filed on Sep. 10, 2002.

(51) Int. Cl. G01N 21/00

(52) U.S. Cl. 422/62; 422/68.1

(57) ABSTRACT

The cellular telephone/breath analyzer combination increases the functionality of the cellular telephone by informing the user of his/her breath quality. The visual display of the cellular telephone displays the breath analysis function. Using the keypad of the cellular telephone, the user can instruct the cellular telephone/breath analyzer to perform a breath analysis. When the user exhales into the breath analyzer, a microcontroller and digital processor disposed within the cellular telephone convert the electrochemical sensor reading into a breath quality indicator on the visual display of the cellular telephone.

### CROSS-REFERENCE TO RELATED APPLICATION(S)

This application claims priority from provisional application serial No. 60/409,481, filed on Sep. 10, 2002, and entitled “Cell Phone/Breath Analyzer”, which is herein incorporated by reference.

### BACKGROUND OF THE INVENTION

The present invention relates to a breath sensor disposed within a portable communications device. In particular, the present invention relates to a breath analyzer for use with a cellular telephone.

The use of cellular telephones is widespread, seemingly with no end to their utility and proliferation in sight. At the touch of a keypad, verbal information can be communicated to parties located at great distances from one another and global information can be accessed from the Internet from nearly any location. Features such as caller ID, voice messaging, appointment books and calculators have added to the convenience and utility of cellular telephones.

A source of self-consciousness for many people is the quality of their breath. The purpose of the breath analyzer is to detect oral malodor and provide the user with an indication of breath quality. Poor breath quality, or bad breath, is typically indicated by the presence of volatile components in the oral cavity. Volatile components of oral malodor include sulfur compounds which are produced by bacteria in the mouth. In most situations, hydrogen sulfide, methylmercaptan, and di-methylmercaptan constitute over 90% of the total volatile sulfur content in mouth malodor.

Thus, there is a need in the art for cellular telephones that can analyze the user's breath quality.

### BRIEF SUMMARY OF THE INVENTION

A combination cellular telephone and breath analyzer of the present invention provides the added functionality of breath analysis to the cellular telephone. The visual display of the cellular telephone provides the user with the option of having the quality of his/her breath analyzed. The user selects this function by pressing the keypad of the cellular telephone and exhaling into a breath analyzer incorporated into the cellular telephone. Once activated, the breath analyzer senses the presence of hydrogen sulfide gas with an electrochemical sensor and utilizes the measured gas concentration as an indicator of breath quality. The breath quality is then conveyed to the user on the visual display of the cellular telephone.

### BRIEF DESCRIPTION OF THE DRAWINGS

FIG. 1 is a front-perspective view showing the cellular telephone and breath analyzer combination of the present invention.

FIG. 2 is a block diagram of the electronics of the cellular telephone and breath analyzer combination of the present invention.

While the above-identified figures set forth preferred embodiments of the invention, other embodiments are also contemplated, as noted in the discussion. In all cases, this disclosure presents the present invention by way of representation and not limitation. It should be understood that numerous other modifications and embodiments can be devised by those skilled in the art which fall within the scope and spirit of the principles of this invention.

### DETAILED DESCRIPTION

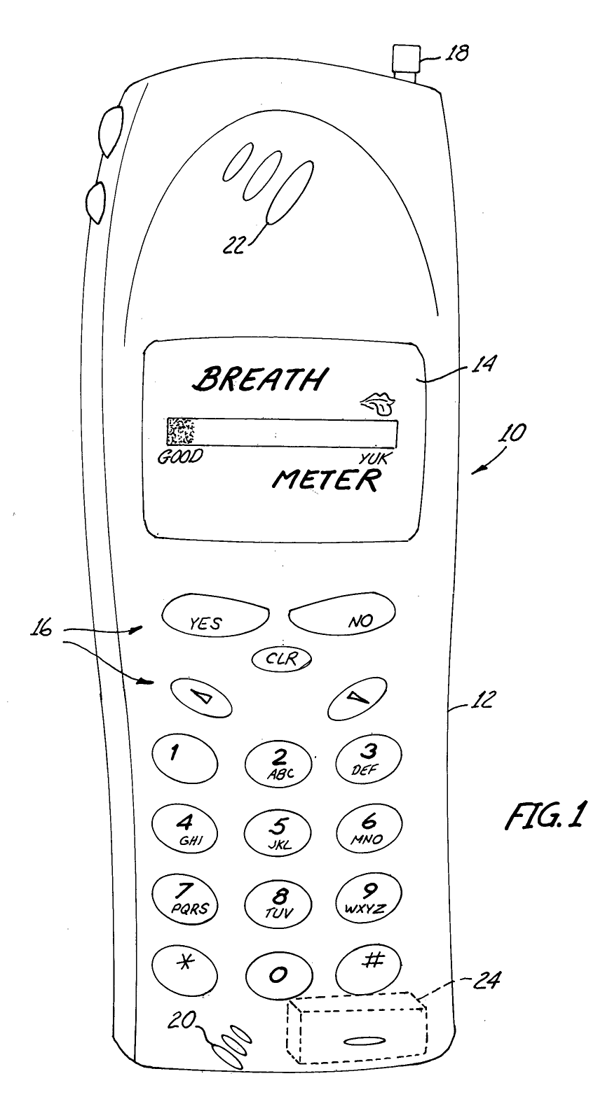

FIG. 1 depicts a typical cellular telephone 10 used to transmit and receive communication signals. The cellular telephone 10 includes a housing 12 sized to fit a human hand that houses conventional electronics for a cellular telephone including a visual display 14, keypad 16, antenna 18, battery (not shown), microphone 20 to receive sound signals, and speaker 22 to provide audio signals to the user. It is common in the art for the visual display 14 to be either a liquid crystal display (LCD) or a plasma display. The display 14 visually informs the user of the various functions available on the cellular telephone 10. The user then provides input to the cellular telephone 10 to perform a particular function by utilizing the keypad 16 to select the desired function from the visual display 14. The housing 12 of the cellular telephone 10 also includes a breath analyzer 24 within it.

The breath analyzer 24 is utilized for detecting the presence of oral malodor. For convenience, the breath analyzer 24 is disposed in the general area of the microphone 20. The breath analyzer 24 can be linked to a distinct and separate circuit for converting the analog sensor signal to a digital signal or to the same circuit board as the cellular telephone 10 with the cellular telephone 10 circuit board accepting signals from the breath malodor analyzer 24. The circuit board of the cellular telephone 10 includes analog-to-digital and digital-to-analog conversion chips that translate outgoing audio signals from analog to digital and incoming signals from digital back to analog. Such chips in the cellular telephone 10 could also be used to convert the signal from the breath sensor 24.

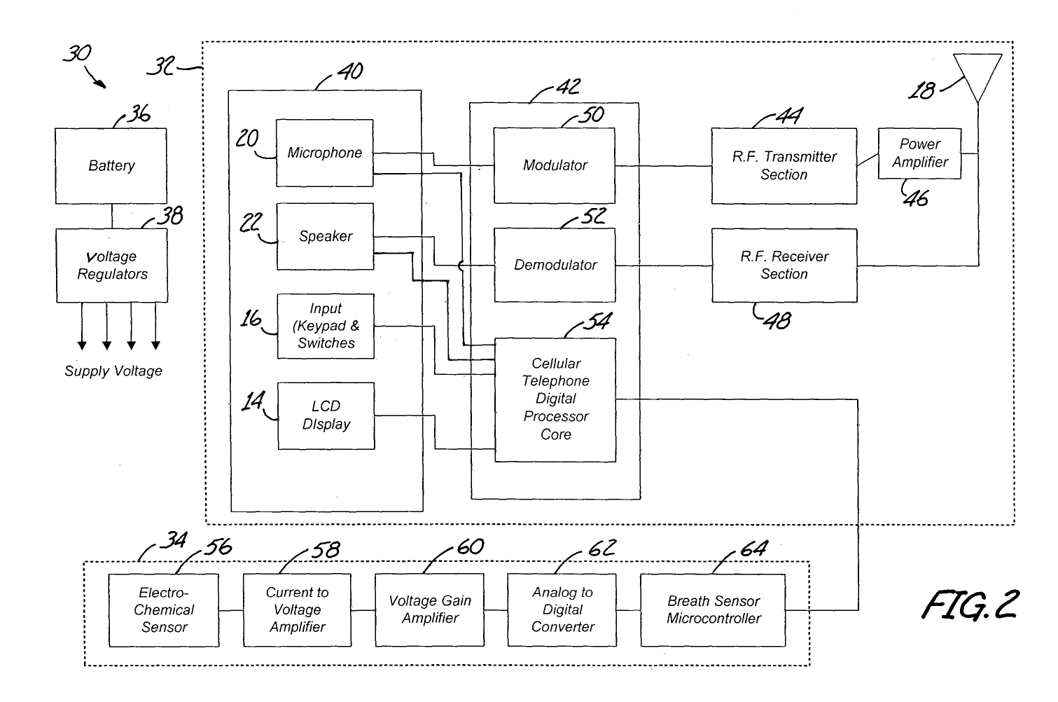

FIG. 2 depicts a block diagram of the circuitry of a cellular telephone/breath analyzer combination 30. As indicated in the block diagram, the implementation of a cellular telephone/breath analyzer 30 is partitioned into two sections: a cellular telephone section 32 and a breath analyzer section 34. In addition, a battery 36 and one or more voltage regulators 38 generate power supply voltages for operation of the cellular telephone/breath analyzer 30 electronics. In order to maximize battery life, both the cellular telephone section 32 and the breath analyzer section 34 of the electronics can be switched to minimum power consumption modes when not in use.

The cellular telephone section 32 of the invention comprises a user interface 40, baseband electronics module 42, radio frequency (R.F.) transmitter 44, power amplifier 46, radio frequency receiver 48, and antenna 18. The user interface 40 includes the microphone 20, speaker 22, keypad 16, and display 14. The baseband electronics module 42 includes modulator 50 and demodulator 52 electronics and a cellular telephone digital processor core 54.

The cellular telephone digital processor core 54 is operatively connected to the keypad and switch 16, which may be used to provide input to the cellular telephone section 32. The digital processor core 54 is also operatively connected to the display, and may optionally be operatively connected to the microphone 20 and to the speaker 22. In this way, the digital processor core 54 is configured to present visual information on the display 14 as well as provide audio indicators through the speaker 22. The microphone 20 may also be connected to the digital processor core 54 to allow voice activation of various features of the cellular telephone 10.

The digital processor 54 also controls the sequence of events when the user communicates using the cellular telephone 10. For instance, the digital processor 54 includes modulator 50 and demodulator 52, and controls the sequence of events when the user verbally communicates into the cellular telephone 10 through the microphone 20. Audio inputs from the microphone 20 are translated into a format suitable for transmission by the modulator 50, converted to a radio frequency signal in the radio frequency transmitter section 44, power boosted by the power amplifier 46, and transmitted through the antenna 18. The radio frequency receiver section 48 amplifies incoming radio signals and converts them into a format that the demodulator 52 can use to generate analog voltage level signals that drive the speaker 22 with audio tone and reconstructed voice information.

The breath analyzer section 34 of the invention comprises an electrochemical sensor 56 that is sensitive to hydrogen sulfide gas, current-to-voltage amplifier 58, voltage gain amplifier 60, analog-to-digital converter 62, and breath sensor microcontroller 64. The breath analyzer section 34 is controlled by the microcontroller 64. When hydrogen sulfide gas is detected by the electrochemical sensor 56, the electrochemical sensor 56 produces a current proportional to the concentration of hydrogen sulfide gas in the current-to-voltage amplifier 58. The output of the current-to-voltage amplifier 58 is then boosted by the voltage gain amplifier 60 to a level that allows the analog-to-digital converter 62 to convert this signal from analog to digital form. The output of the analog-to-digital converter 62 is transferred to the breath sensor microcontroller 64 for scaling as an indicator of breath quality. A measurement of low or no concentration of hydrogen sulfide gas is indicated as good breath quality. A measurement of high concentration of hydrogen sulfide gas is indicated as poor breath quality. Measurements between low and high hydrogen sulfide concentrations may also be indicated on a relative breath quality scale between the two extremes.

The expected useful lifetime of an electrochemical sensor is two to three years. In one embodiment, the electrochemical sensor 56 element can be constructed as a user replaceable module. The breath sensor microcontroller 64 can be programmed to monitor the condition of the electrochemical sensor 56 and alert the user when it needs to be replaced.

The breath analyzer section 34 is operatively connected to and is also controlled by the cellular telephone digital processor core 54. For instance, the interface between the cellular telephone section 32 and the breath analyzer section 34 may be a bi-directional digital serial data communications link between the cellular telephone digital processor core 54 and the breath sensor microcontroller 64. In this embodiment, the serial data communications link utilizes a UART (universal asynchronous receiver transmitter) for full duplex serial data transfer. The UART is a logical choice for this design because many microcontrollers and other digital processors are available with these devices built in. However, those skilled in the art will recognize that there are many types of serial data communication links that can be used.

In operation, the user selects the breath analyzer function using the keypad 16. The cellular telephone digital processor 54 then issues a request for a breath analysis to the breath sensor microcontroller 64, such as by serial communications interface, and instructs the user either audibly via the speaker 22 or visually via the display 14 to exhale into the breath sensor 24 on the face of the cellular telephone 10. Once the breath analysis is completed, the breath sensor microcontroller 64 transmits the results of the analysis by the serial communications interface to the cellular telephone digital processor 54. The digital processor 54 then outputs the analysis results, such as via the visual display 14 or via the speaker 22.

The design of the cellular telephone section 32 presented is not intended to be an exhaustive description of cellular telephone technology. The simplified description of electronics circuitry representative of a cellular telephone is presented as an aid to understanding the invention. This design embodiment maintains a clear separation between the cellular telephone section 32 and breath analyzer section 34 in order to clearly describe the unique features of the invention. As an alternative embodiment, the cellular telephone section 32 and breath analyzer section 34 may be integrated into a single unit to minimize physical size and to reduce manufacturing cost. In addition, the breath analyzer section 34 analog-to-digital converter 62 and breath analyzer microcontroller 64 functions could be integrated into the cellular telephone digital processor core 54. Under this embodiment, the interface between the breath analyzer and cellular telephone sections 32, 34 would be the analog voltage output of the breath analyzer section 34 voltage gain amplifier 60.

Although the present invention has been described with reference to preferred embodiments, workers skilled in the art will recognize that changes may be made in form and detail without departing from the spirit and scope of the invention.

1. A portable communications device for sending and receiving verbal communications having a housing sized to fit a human hand, characterized by:
a breath analyzer within the housing for sensing volatile components of oral malodor and providing a breath analyzer output based upon the sensed volatile components; and
a user interface carried by the housing for providing an output based upon results of a breath test performed by the breath analyzer.

2. The portable communications device of claim 1, the breath analyzer comprising an electrochemical sensor for sensing volatile components of oral malodor and providing an electrochemical sensor output based upon the sensed volatile components.

3. The portable communications device of claim 2 wherein the breath analyzer further comprises a current-to-voltage amplifier and a voltage gain amplifier.

4. The portable communications device of claim 3 wherein the breath analyzer further comprises an analog-to-digital converter.

5. The portable communications device of claim 1 wherein the breath analyzer further comprises a controller for scaling the breath analyzer output.

6. The portable communications device of claim 1 and further comprising input for activating the breath analyzer.

7. The portable communications device of claim 1 wherein the user interface is a visual display.

8. The portable communications device of claim 7 wherein the visual display is a liquid crystal display.

9. The portable communications device of claim 7 wherein the visual display is a plasma display.

10. The portable communications device of claim 1 wherein the user interface is a speaker.

11. A cellular telephone, an improvement comprising:
a user input to select a breath analysis;
a breath analyzer for sensing volatile components of oral malodor and providing a breath analyzer output based upon the sensed volatile components; and
a processor for processing the breath analyzer output and providing a user perceivable output reporting the breath analysis based on the processed breath analyzer output.

12. The cellular telephone of claim 11 wherein the breath analyzer further comprises an electrochemical sensor for sensing the volatile components of oral malodor.

13. The cellular telephone of claim 12 wherein the electrochemical sensor provides an electrochemical sensor output based upon the sensed volatile components.

14. The cellular telephone of claim 13, wherein the breath analyzer further comprises a controller for scaling the electrochemical sensor output.

15. The cellular telephone of claim 12, wherein the breath analyzer further comprises a current-to-voltage amplifier and a voltage gain amplifier.

16. The cellular telephone of claim 15, wherein the breath analyzer further comprises an analog-to-digital converter.

17. The cellular telephone of claim 11, wherein the user perceivable output is a visual display.

18. The cellular telephone of claim 17, wherein the visual display is a liquid crystal display.

19. The cellular telephone of claim 17, wherein the visual display is a plasma display.

20. The cellular telephone of claim 11, wherein the user perceivable output is an audible indicator.

21. A portable communications device comprising:
a keypad for selecting a breath analysis;
an antenna;
a microphone for receiving verbal signals from a user;
a speaker for providing audio signals to the user;
communications electronics connected to the microphone, the speaker and the antenna for transmitting and receiving communications signals;
a visual display for providing a visual output;
a breath analyzer for sensing volatile components of oral malodor and providing a breath analyzer output based upon the sensed volatile components; and
a digital processor for controlling the visual display to provide a visual output based on the breath analyzer output.

22. The portable communications device of claim 21, the breath analyzer comprising an electrochemical sensor for sensing volatile components of oral malodor and providing an electrochemical sensor output based upon the sensed volatile components.

23. The portable communications device of claim 22, wherein the breath analyzer further comprises a current-to-voltage amplifier and a voltage gain amplifier.

24. The portable communications device of claim 23, wherein the breath analyzer further comprises an analog-to-digital converter.

25. The portable communications device of claim 24, wherein the breath analyzer further comprises a controller for scaling the results of the electrochemical sensor output.

26. The portable communications device of claim 21, wherein the visual display is a liquid crystal display.

27. The portable communications device of claim 21, wherein the visual display is a plasma display.
